(19) United States
(12) Patent Application Publication
(10) Pub. No.: US 2013/0335658 A1
(43) Pub. Date: Dec. 19, 2013

(54) Pixel Architecture for Electronic Displays

(71) Applicant: APPLE INC., Cupertino, CA (US)

(72) Inventors: Chun-Yao Huang, Cupertino, CA (US); Kyung Wook Kim, Cupertino, CA (US); Shih Chang Chang, Cupertino, CA (US); Szu-Hsien Lee, Cupertino, CA (US); Young Bae Park, Cupertino, CA (US)

(73) Assignee: Apple Inc., Cupertino, CA (US)

(21) Appl. No.: 13/629,524

(22) Filed: Sep. 27, 2012

Related U.S. Application Data
(60) Provisional application No. 61/660,192, filed on Jun. 15, 2012.

(51) Int. Cl. G02F 1/136

(52) U.S. Cl. 349/42

(57) ABSTRACT

An electronic display for providing a visual or video output for an electronic device. The electronic device includes a transistor layer configured to activate a first pixel row and a second pixel row. For each pixel in the first pixel row and the second pixel row, the transistor layer includes a switch transistor, a pixel electrode, and a common electrode. The electronic device further includes a pixel controller for selectively activating each pixel. The pixel controller includes a first gate line, a first drive line, and a second drive line. During operation, the first gate line provides a charge to the pixel electrode for a first pixel in the first pixel row and for a second pixel in the second pixel row, and the first drive line activates the switch transistor for the first pixel, and the second drive line activates the switch transistor for the second pixel.

### CROSS-REFERENCE

The present invention claims the benefit under 35 U.S.C. §119(e) to U.S. Provisional Patent Application No. 61/660,192, filed on Jun. 15, 2012, and entitled “Pixel Architecture for Electronic Displays,” which is incorporated by reference as if fully disclosed herein.

### TECHNICAL FIELD

The present invention relates generally to display screens, and more specifically, to structures forming a transistor layer for activating a plurality of pixels.

### BACKGROUND

Display devices, such as light crystal displays (LCDs), are commonly used to provide a visual output for a wide variety of electronic devices including televisions, computers, and handheld devices (e.g., smart phones, audio/video players, and gaming systems). LCD devices typically include a plurality of picture elements, e.g., pixels, arranged in a matrix. The pixels may be driven by scanning lines and data lines (which may be controlled by one or more processors) to display an image that may be perceived by a user. Individual pixels of a LCD device may variably permit light to pass therethrough when an electric field is applied to a liquid crystal material in each pixel. Moreover certain LCD devices, such as in-plane switching (IPS) and fringe field switching (FFS) display panels, may supply a common voltage (Vcom) to a common electrode to each row of pixels. Each of the pixels may require a specific charging time to store a required charge to properly activate. However, the longer the charging rate, the lower the refresh rate for the LCD device. Additionally, reductions in charging time may further limit the resolution of the LCD and insufficient charging time may cause certain display artifacts, such as mura or spots.

### SUMMARY

One example of the present disclosure may take the form of an electronic display for providing a visual or video output for an electronic device. The electronic device includes a transistor layer configured to activate a first pixel row and a second pixel row. For each pixel in the first pixel row and the second pixel row, the transistor layer includes a switch transistor, a pixel electrode, and a common electrode. The electronic device further includes a pixel controller for selectively activating each pixel. The pixel controller includes a first gate line, a first drive line, and a second drive line. During operation, the first gate line provides a charge to the pixel electrode for a first pixel in the first pixel row and for a second pixel in the second pixel row, and the first drive line activates the switch transistor for the first pixel, and the second drive line activates the switch transistor for the second pixel.

### BRIEF DESCRIPTION OF THE DRAWINGS

FIG. 1A is a front elevation view of an exemplary display incorporating a transistor layer to selectively activate and deactivate one or more pixels.

FIG. 1B is a side perspective view of another example of a display incorporating the transistor layer of FIG. 1A.

FIG. 2 is a simplified block diagram of the electronic device of FIG. 1B.

FIG. 3 is an exploded simplified view of a pixel of the display.

FIG. 4A is a top schematic view of a conventional transistor layer for the display.

FIG. 4B is a top schematic view of another example of a conventional transistor layer for the display.

FIG. 5 is a top schematic view of a transistor layer for the electronic display having a reduced number of gate lines.

FIG. 6 is a simplified layered cross-section view of the transistor layer of FIG. 5.

### SPECIFICATION

### Overview

In some embodiments described herein a pixel architecture for electronic displays is disclosed. The pixel architecture may include two or more pixels where each pixel may be individually controlled by one or more transistors. For example, the display may include a transistor layer including two or more transistors, where each one of the transistors may selectively activate a respective pixel based on one or more signals from a controller or processor. Each transistor may be communicatively coupled to a data line and a gate line. The data lines may provide image signals which may be used to activate the pixels based on a desired visual output for the electronic display. The gate lines may provide an activation charge to the transistors, and when “on” the transistors may store the image signals from the data line. In some embodiments, the transistor layer may include one gate line for every two pixel rows. In these embodiments, the charging time for the entire display may be reduced, as the charging time is typically dependent on the number of gate lines.

Each transistor of the transistor layer is communicatively coupled to a gate line, but adjacent pixels may share the same gate line. Generally, pixels for LCDs may be charged sequentially in rows, and with the transistor layer of the present disclosure, the number of gates lines are reduced, the pixels of a display incorporating the transistor layer may be charged more quickly. Accordingly, each pixel may be able to be sufficiently charged, reducing display artifacts such as mura.

In some embodiments, the transistor layer may further include an increased amount of data lines compared to conventional displays. The additional data lines may allow the display to maintain its resolution, despite the reduction in gate lines. In other words, each junction of a gate line and a data line may activate a single pixel, maintaining the resolution of the display. Thus, each data line may provide for individual control over each of the pixels, although two or more pixels may be charged by a single gate.

In yet other embodiments, the display may also communicatively couple each pixel to a common voltage source (for a common electrode, discussed in more detail below) through a conductive material or conductive layer within the display stack. As an example, the transistor layer may include one or more communication apertures which may allow a portion of the pixel to be in communication with a metallic trace or metal layer positioned beneath the transistor layer. By providing the common voltage for the common electrode as a separate layer, the resistance experienced by the Vcom signal may be reduced. This is because the metal layer may have a reduced resistance compared to the transistor layer, which in many embodiments may be formed at least in part by Indium tin oxide (ITO), which may have an increased resistance compared to metal traces. In some instances the metal traces may be positioned beneath the location of the removed gate lines, so that the display of the present disclosure may not have a reduction in aperture ratio. That is, the metal traces may be aligned with space on the transistor layer that conventionally may have included non-transparent materials (removed gate lines), and thus the display may not need to reduce the transmission area of each pixel.

### DETAILED DESCRIPTION

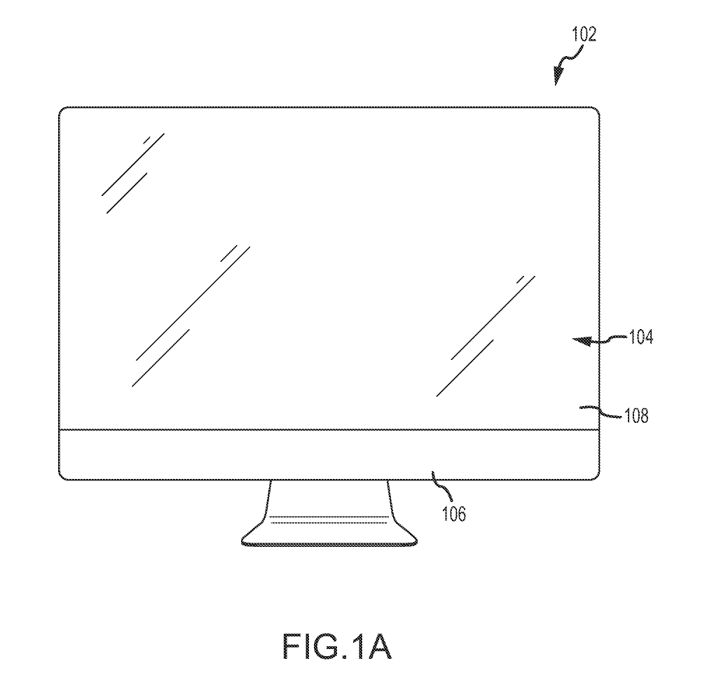

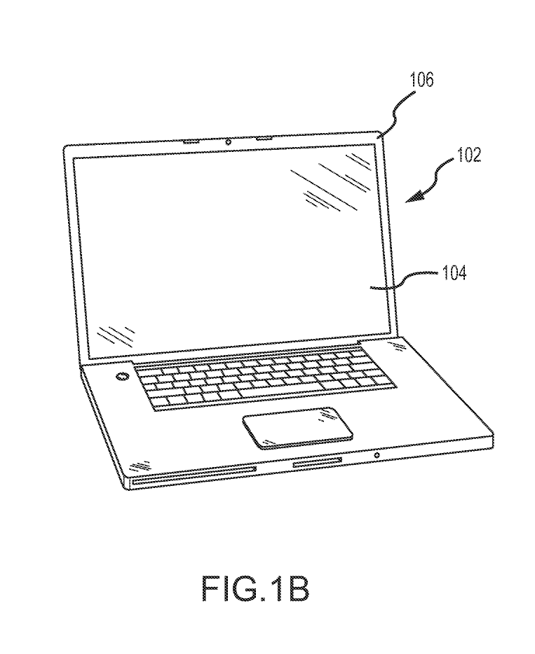

Turning now to the figures, the transistor layer or pixel architecture of the present disclosure may be incorporated into a display for an electronic device. FIG. 1A is a front perspective view of a first example of an electronic device including a display. The electronic device 102 may include a display 104 and optionally an enclosure 106 supporting and at least partially surrounding the display 104. The electronic device 102 may be a display device and configured to be in communication with one more computers or processing devices, e.g., a standalone monitor for a computer. For example, the electronic device 102 may be configured to receive inputs from one or more external sources.

Additionally or alternatively, the electronic device 102 may be self-supported, such as a laptop, television, or the like. FIG. 1B is a side perspective view of a second example of an electronic device including a display. As shown in FIG. 1B, the device 102 may be a laptop which may include an integrated display 104. In these embodiments, the display 104 may include its own processing components, or may utilize the components of the device 102 instead.

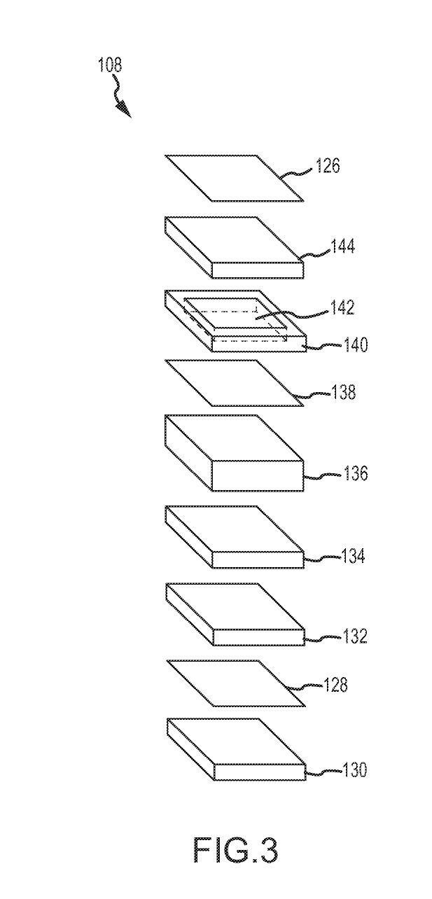

In many embodiments, the display 104 may be configured to display a visual output for the electronic device 102. The structure of the display 104 will be discussed in more detail with respect to FIG. 3, but generally may include a plurality of pixels 108 that may be configured to be selectively activated in order to emit various combinations of light and light colors to provide a visual output for the device 102.

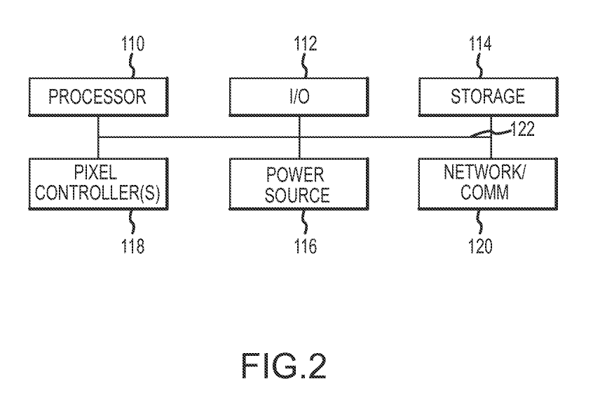

Select components of the electronic device 102 will now be discussed in further detail. FIG. 2 is a simplified block diagram of the electronic device 102. The electronic device 102 may include a processor 110, an input/output interface 112, one or more storage components 114, a power source 116, one or more pixel controllers 118, and/or a network/communication interface 120, which will each be discussed in turn, below.

The processor 110 may control operation of the electronic device 102. The processor 110 may be in communication, either directly or indirectly, with substantially all of the components of the electronic device 102. For example, one or more system buses 122 or other communication mechanisms may provide communication between the processor 110, the display 104, the pixel controller 118, storage 114, and so on. The processor 110 may be any electronic device cable of processing, receiving, and/or transmitting instructions. For example, the processor 110 may be a microprocessor or a microcomputer.

The input/output (I/O) interface 112 may provide communication between the electronic device 102 and one or more output devices, such as but not limited to, speakers, mice, joysticks, cameras, and/or mobile electronic devices. In some instances, the I/O interface 112 may include one or more receiving ports to receive cables or other connectors corresponding to the one or more input/output devices, such as a universal serial bus cable, or a power cable.

The storage component 114 may store electronic data that may be utilized by the electronic device 102. For example, the storage component 114 or memory may store electrical data or content e.g., audio files, video files, document files, and so on, corresponding to various applications. The storage component 114 may be, for example, non-volatile storage, a magnetic storage medium, optical storage medium, magneto-optical storage medium, read only memory, random access memory, erasable programmable memory, or flash memory.

The pixel controller 118 may be a processor or other computing element which may control one more elements of the display 104, such as the pixels 108. The pixel controller 118 will be discussed in more detail below, but generally may selectively activate and control the pixels 108 by controlling one or more transistors and/or electrodes. In some embodiments, the pixel controller 118 may include a gate line driver, a drive line driver, and/or a common line driver, which may each provide various signals to one or more elements of each pixel of the display 104.

The power source 116 may provide power to the electronic device 102 and may be incorporated into the electronic device 102 or separate therefrom. For example, the electronic device 102 may include one or more batteries which may provide power to the components of the device 102, and/or the device 102 may include one more power transmission mechanisms (e.g., power cords) to receive power from an external source such as a wall outlet.

The network/communication interface 120 may be used to receive data from a network, or may be used to send and transmit electronic signals via a wireless or wired connection (Internet, WiFi, Bluetooth, and Ethernet being a few examples). In some embodiments, the network/communication interface 120 may support multiple network or communication mechanisms. For example, the network/communication interface 120 may pair with another device over a Bluetooth network to transfer signals to the other device, while simultaneously receiving data from a WiFi or other network.

The display 104 will now be discussed in further detail. In some embodiments, the display 104 may be a liquid crystal display (LCD), which may include a panel having an array or matrix of picture elements, i.e., pixels 108. In these embodiments, the display 104 may modulate the transmission of light through the pixels 108 by controlling the orientation of liquid crystal disposed at each pixel 108. LCDs may operate in a variety of different manners; however, in general the orientation of the liquid crystals is controlled by a varying an electric field associated with each respective pixel 108 with the liquid crystals being oriented at any given instant by the properties, strength, shape, and so forth, of the electric field.

Different types of LCDs may employ different techniques to manipulate these electrical fields and/or the liquid crystals. For example certain displays may employ transverse electric field modes in which the liquid crystals are oriented by applying an in plane electrical field to a layer of the liquid crystals. Example of such techniques include in plane switching (IPS) and fringe field switching (FFS) techniques, which may include different electrode arrangements employed to generate the respective electrical fields. While control of the orientation of the liquid crystals in such displays may be sufficient to modulate the amount of light emitted by the pixels 108, one or more color filters may also be associated with the display to further vary the colors of light emitted by the pixels 108. In instances where the display 104 is a color display, the pixels 108 may be grouped by colors, where each pixel 108 may correspond to a different primary color. For example, in one embodiment, each pixel grouping may include a red pixel, a green pixel, and a blue pixel each associated with an appropriately colored filter. The intensity of light allowed to pass through each pixel by modulation of the corresponding liquid crystals and its combination with the light emitted from other adjacent pixels determines what colors may be perceived by a user viewing the display 104.

Turning again to figures, FIG. 3 is a simplified exploded view of different layers of the display for one pixel 108. It should be noted that although FIG. 3 is discussed with reference to a single pixel 108, in many instances, one or more layers, such as, one or more of the polarizers, may expand across the entire area (or a substantial portion thereof) of the display 104. The pixel 108 includes an upper polarizing layer 126 and a lower polarizing layer 128 that polarize light emitted by a backlight assembly 130 or light reflective surface. A lower substrate 132 may be disposed above the polarizing layer 128 and is generally formed from a light transparent material such as glass quartz and or plastic.

A transistor layer 134 or pixel architecture, which may include one more transistors, such as thin film transistors (TFTs), may be disposed above the lower substrate 128. It should be noted that FIG. 3 illustrates a simplified view of the transistor layer 134, and the transistor layer 134 will be discussed in more detail below. The transistor layer 134 interfaces with a liquid crystal layer 136.

The liquid crystal layer 136 may include liquid crystal particles or molecules suspended in a fluid or gel matrix. The liquid crystal particles 136 may be oriented or aligned with respect to an electrical field generated by the transistor layer 134. The orientation of the liquid crystal particles in the liquid crystal layer 136 determines the amount of light transmission through the pixel 108. Varying the electric field applied to the liquid crystal layer 136 varies the amount of light transmitted though the pixel 108.

One or more over-coating/alignment layers 138 may be disposed on the liquid crystal layer 136 opposite from the transistor layer 134. The over-coating/alignment layers 138 may be positioned between the liquid crystal layer 136 and a color filter 142. Depending on the display 104, the color filter 142 may include red, blue, or green component which may be aligned with one or more pixels, so that each pixel may correspond to a primary color when light is transmitted from the backlight 130 through the liquid crystal layer 136 and color filter 142.

In some embodiments, the color filter 142 may be at least partially surrounded by a black mask 140. The black mask 140 may determine the light transmissive portion of the pixel 108. For example, the black mask 140 may define one or more transmission apertures over the liquid crystal layer 136 and color filter 142. Additionally, the mask 140 may also function to conceal one or more portions of the pixel 108 that may not transmit light, e.g., certain components of the transistor layer 134. An upper substrate 144 may be positioned between the polarizer 126 and the black mask 140 and color filter 142.

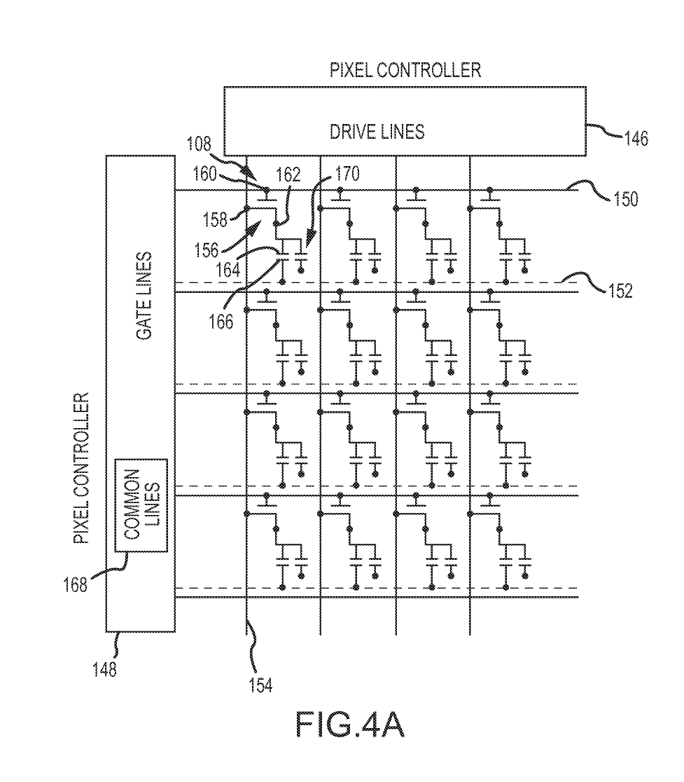

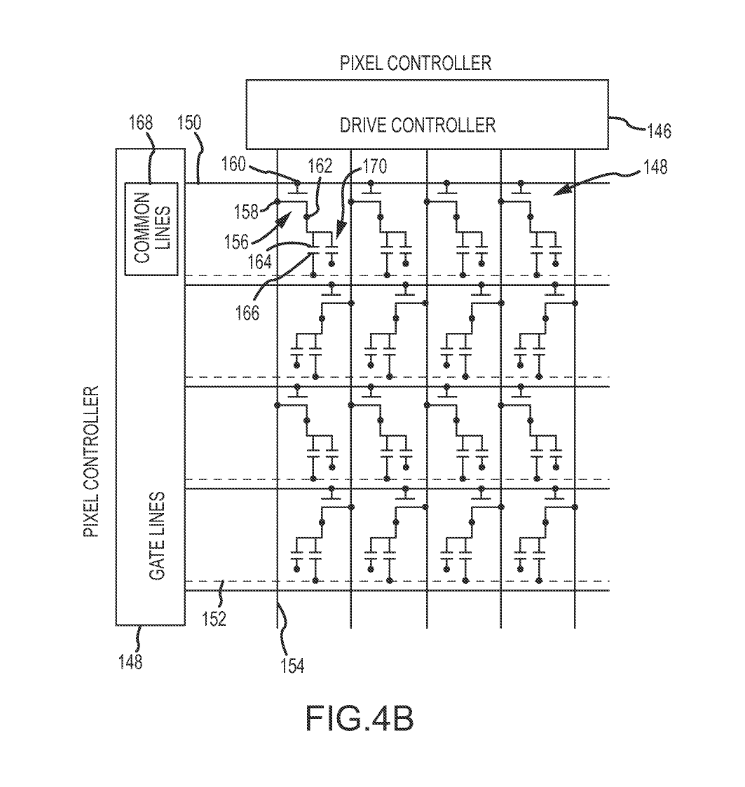

A conventional transistor layer will now be discussed in more detail. FIG. 4A is a top schematic view of a conventional transistor layer 134. FIG. 4B is a top schematic view of a conventional transistor layer 134 including transistors alternatively arranged in rows. As shown in FIGS. 4A and 4B, the transistor layer 134 may include various conductive, non-conductive, and semiconductive layers and structures which generally form the electrical devices and pathways which drive operation of the pixel 108.

In conventional LCD displays, the transistor layer 134 may include a low temperature polycrystalline silicon LCD and both the pixel controller 118 and the pixel circuitry may be incorporated into the transistor layer 134. As shown in FIGS. 4A and 4B, each pixel 108 may be formed in a matrix that forms at least a portion of the video output region of the display 104. Each pixel 108 may generally be defined by the intersection of data or source lines 154 and gate or scanning lines 150. As will be discussed in more detail below, the data lines 154 may be controlled by a data line controller 146 and the gate lines 150 may be controlled by a gate line controller 148, which may be incorporated into the pixel controller 118. Additionally, the pixels 108 may also include common lines 152 that apply voltages to common electrodes of the pixel 108, discussed in more detail below. In conventional LCD displays, each pixel may be in communication with a its own data line 154 and its own gate line 150.

It should be noted that in some instances, conductive structures, such as the gate and/or data lines may be formed of using transparent conductive materials such as indium tin oxide (ITO). This is because some conductive structures in may be positioned in the light transmitting portions of the pixel 108. Additionally, the transistor layer 134 may include insulating layers such a gate insulating film formed from suitable transparent materials such as silicon oxide and semi-conductive layers formed from suitable semiconductor materials such as amorphous silicon. In general the respective conductive structures and traces insulating structures and semiconductor structures may be suitably disposed to form the respective pixel and common electrodes.

Each pixel 108 includes a pixel electrode 164 and thin film transistor (TFT) 156 coupled to the pixel electrode 164 to selectively activating the electrode 164. In FIG. 4A the TFTs 156 for each pixel in a respective row of pixels 108 are orientated in the same direction (with respect to the data lines 154). Alternatively, as shown in FIG. 4B the TFTs 156 for each pixel of a respective pixel row are orientated in opposite directions relative to adjacent pixel rows. In both examples, a source 158 of each TFT 156 is communicatively coupled a data line 154 extending from the data line controller 146. Similarly, a gate 160 of each TFT 156 is communicatively connected to a scanning or gate line 150 that extends from the gate line controller 148. Further, the pixel controller 118 may further include a common line drive controller 168, which may be incorporated into the gate controller 148 or separate therefrom. The pixel electrode 164 is electrically connected to a drain 162 of the TFT 156.

In operation, the data line controller 146 sends image or data signals to the pixels 108 through one of the respective data lines 154. The image signals are generally applied by line sequence. In other words, the data lines 154 may be sequentially activated along the horizontal length (x axis) of the transistor layer 134. The gate lines 150 apply scanning signals from the gate controller 148 to the gate 160 of each TFT 156 to which the respective scanning lines 148 connect. As briefly mentioned above, in conventional LCD displays, each TFT 156 for a given array of pixels is connected to its own gate line 150. Hence, if there are five pixels, there may be five gate lines 150, so that each TFT 156 for each pixel 108 may be connected to its own gate line 150. Generally, during operation, the gate or scanning signals are applied line 150 by line 150 with a predetermined timing and/or in a pulse manner. The scanning signals applied by the gate lines 154 provides a charging signal to activate the TFT 156 and prepare the pixel electrode 164 to receive a charge from the data line 154.

In other words, each TFT 156 acts as a switching element that is activated and deactivated (turned on/off) for a predetermined period based on whether there is a signal applied to the gate line 150 at the gate 160. When activated, each TFT 156 may store the image signals received through the data line 154 as as a charge in the pixel electrode 164 with a predetermined timing.

The image signals stored at the pixel electrode 164 may be used to generate an electrical field between the respective pixel electrode 164 and the common electrode 166. Such an electrical field may align liquid crystals within the liquid crystal layer 136 to modulate light transmission therethrough. Additionally, in some embodiments, a storage capacitor 170 may also be provided in parallel to the liquid crystal capacitor formed between the pixel electrode 164 and the common electrode 166. The storage capacitor 170 may help prevent leakage of the stored image signal at the pixel electrode 164. For example such a storage capacitor may be provided between the drain 162 of the respective TFT 156 and a separate capacitor line.

With conventional transistor layers 134, as shown in FIGS. 4A and 4B, each TFT 156 is communicatively coupled to its own gate line 150 to provide an activation signal to the respective pixels. Such that if there are four pixel rows, there may be four gates lines, one gate line for each row of pixels. However, because each pixel row has its own gate line 150, and because the gate controller 148 typically scans along rows (e.g., vertical or y axis), the charging time for each pixel depends on the resolution of the y axis (that is, how many gate lines 150 are present). Accordingly, generally the charging ratio for a LCD display is equal to the 1/(frame rate×number of gate lines). As the number of gate lines increased (for instance as the display size increases) the charging time reduces for each pixel. Thus for large displays, which may include a significant number of pixels 108, the charging time for each pixel 108 may be substantially reduced. As the charging time for each pixel 108 reduces, the display 104 may develop one or more display artifacts, such as a mura which may cause darkened spots to appear across the output area. This is because some pixels may be fully charged, whereas other pixels which may not be fully charged. For example, if a display scans the gate lines 150 sequentially from a bottom of the display to a top of the display, the pixels at the bottom may be fully charged whereas the pixels as the top may not be fully charged. The charging time differences may cause many front of screen issues, and the brightness difference between pixels 108 at different locations may be noticeable to the user.

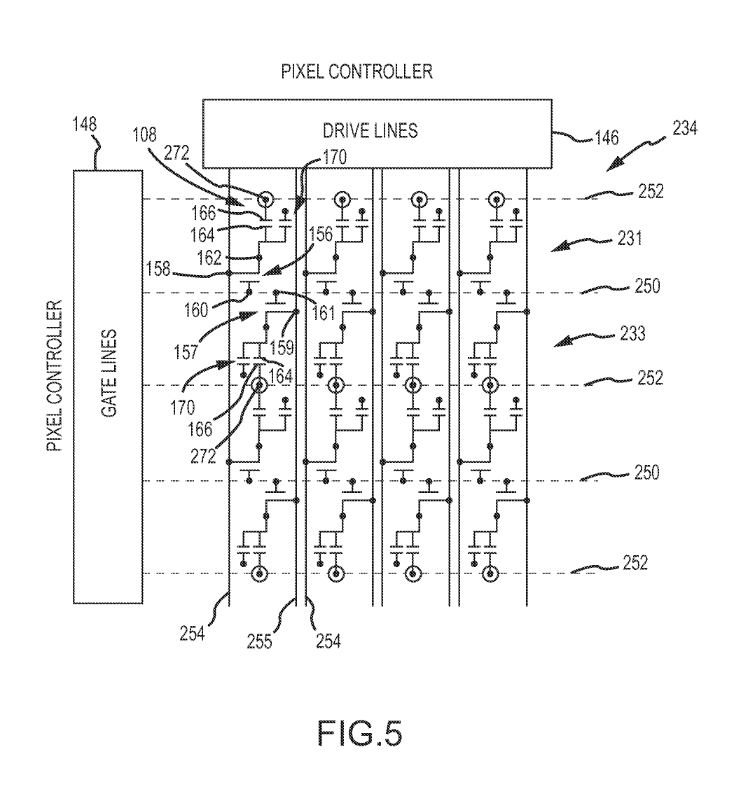

In embodiments of the present disclosure, the display 104 may include a transistor layer 234 having fewer gate lines per pixel array, which may reduce the required charging time for the display. FIG. 5 is a top schematic view of a transistor layer 234 having a reduced number of gate lines 250. With reference to FIG. 5, in the pixel array of the transistor layer 234, only every other pixel row includes a gate line 250. However, each gate line 250 for a particular junction provides scanning signals to the gates 160, 161 to two rows of TFTs 156, 157. This may allow for the TFTs 156, 157 for adjacent rows to receive the scanning signal substantially simultaneously. Because adjacent pixel rows may receive the scanning signal substantially simultaneously, the scanning time for the pixel array may be reduced, while allow each pixel electrode 164 to have sufficient time to charge between frames. This is because the number of lines to be scanned for a predetermined display screen size may be reduced, which may allow for increase in charging time without a reduction in frame rate.

As discussed above, the scanning time for a particular display depends on the number of gate lines, and the longer it takes to scan the gate lines, the shorter the charging time for pixels within the pixel array. In the TFT layer 234 of FIG. 5, the gate scanning time may be reduced by approximately half, increasing the charging time of select pixels by almost double. To maintain the resolution of the pixel array, despite the reduction in gate lines, the number of data lines may be increased by double. In this way, each pixel 108 may remain individually controlled, although adjacent pixel rows may receive the scanning signal from the gates lines substantially simultaneously. In other words, each pixel 108 may still be defined as the junction between a data line and a gate line, where adjacent pixels may receive the scanning signal from the same gate line but may receive the data signal from separate data lines.

In the TFT layer 234, TFTs in vertically adjacent rows may be inverted relative to each other. That is, the TFT 156 for a first row 231 may have its gate 160 connected to a gate line 250 on a bottom of the pixel 108, whereas the TFT 157 for a second row 233 may have its gate 161 connected to the gate line 250 which may be on a top end of the pixel 108. Additionally, the first TFT 156 may have its source 158 connected to a first data line 254 on a left side (with reference to FIG. 5) of the pixel 108, whereas the second TFT 157 may have its source 159 connected to a second data line 255 on a right side of the pixel 108. In other words, the TFTs of adjacent pixel rows may be asymmetric with respect to one another.

Additionally, with continued reference to FIG. 5, in some embodiments, voltage may be provided to the common electrode 166 through one or more conductive traces that may be positioned beneath the transistor layer 234. For example, the display 104 may include a plurality of metal or other conductive traces 252, and the common lines 152 may be omitted. In these embodiments, the metal traces 252 may not be transparent, as they may not be a transparent material such as ITO (which may conventionally be used for the TFTs). As such, in some instances, the metal traces 252 may be positioned beneath the pixel array and a connection aperture 272 may be defined through the transistor layer 234 to communicatively couple the common electrode 166 to the common voltage source provided through the metal trace 252. In these embodiments, the metal traces 252 may reduce the resistance experienced by the common voltage, as generally metal may be more conductive than ITO. However, it should be noted that in other embodiments, the common lines may be constructed out of ITO rather than metal or other non-transparent conductive materials.

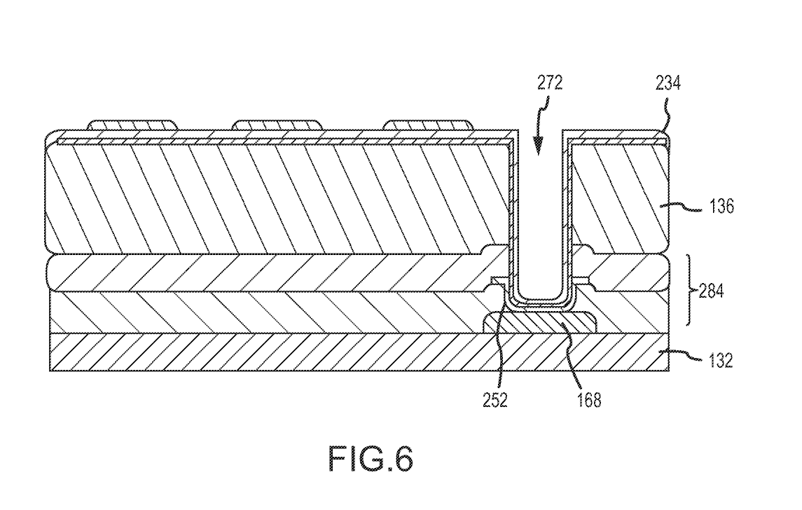

FIG. 6 illustrates simplified cross-sectional view of the display 104 to illustrate the connection apertures 272 connecting the common electrode 166 to the conductive traces 252. With reference to FIG. 6, the connection apertures 272 may be defined through the transistor layer 234, as well as one or more components of the display 104 (e.g., liquid crystal layer 136, on or more insulators 284) to connect the conductive traces 252 with the common electrode 166. As an example, the common electrode conductive traces 252 may be formed as an additional layer in the display 104 stack. The conductive traces 252 may be in communication with the common lines driver 168 to activate the common electrode 166. As shown in FIG. 6, at the connection apertures 272 one or more connective regions of the pixel 108 may be placed into communication with the conductive traces 252.

In some embodiments, the conductive traces 252 may be positioned beneath the transistor layer 234 in locations aligned with locations of the removed gate lines. For example, with reference to FIGS. 4A and 5, the conductive traces 252 may be configured so as to align with the pixel 108 at the location of the removed gate lines. In these embodiments, the aperture ratio of the display 104 may remain substantially the same between the first conventional transistor layer 134 and the transistor layer 234 of FIG. 5. This is because the non-light emitting portions of the display 104 used for the removed gate lines may be re-purposed to include the conductive traces 252.

### Conclusion

The foregoing description has broad application. For example, while examples disclosed herein may focus on the transistor layer for a LCD, it should be appreciated that the concepts disclosed herein may equally apply to substantially any other type of display where one or more pixels is activated by a transistor. Similarly, although the display may be illustrated as part of a computer or larger electronic device, the devices and techniques disclosed herein are equally applicable to other types of electronic devices, such as mobile or handheld electronic devices. Accordingly, the discussion of any embodiment is meant only to be exemplary and is not intended to suggest that the scope of the disclosure, including the claims, is limited to these examples.

1. A display for providing a visual output for an electronic device, comprising:
a transistor layer for activating a first pixel row and a second pixel row, wherein the transistor layer for each pixel in the first pixel row and the second pixel row includes
a switch transistor;
a pixel electrode; and
a common electrode;
a pixel controller for selectively activating each pixel including
a first gate line;
a first drive line; and
a second drive line; wherein p1 the first gate line provides a charge to the pixel electrode for a first pixel in the first pixel row and for a second pixel in the second pixel row; and
the first drive line activates the switch transistor for the first pixel, and the second drive line activates the switch transistor for the second pixel.

2. The display of claim 1, further comprising a conductive layer in communication with the pixel controller, wherein the conductive layer activates the common electrode for the first pixel and the second pixel.

3. The display of claim 2, wherein the transistor layer further includes one or more conductive apertures that communicatively connect the common electrode to the conductive layer.

4. The display of claim 2, wherein the conductive layer is formed of a metallic element.

5. The display of claim 1, wherein each pixel in the first pixel row and each pixel in the second pixel row further comprises a liquid crystal layer in communication with the transistor layer, wherein the switch transistor selectively aligns crystals in the liquid crystal layer.

6. The display of claim 1, wherein the first gate line provides the charge to the first pixel and the second pixel substantially simultaneously.

7. A computer comprising:
a processor;
a storage component in communication with the processor;
a display in communication with the processor and the storage component, the display comprising:
a transistor layer for activating a first pixel row and a second pixel row, wherein the transistor layer for each pixel in the first pixel row and the second pixel row includes
a switch transistor
a pixel electrode; and
a common electrode;
a pixel controller for selectively activating the transistor layer including
a first gate line;
a first drive line; and
a second drive line; wherein
the first gate line provides a charge to the pixel electrode for a first pixel in the first pixel row and for a second pixel in the second pixel row; and
the first drive line activates the switch transistor for the first pixel, and the second drive line activates the switch transistor for the second pixel.

8. The computer of claim 7, wherein the switch transistor for the first pixel row is inverted relative to the switch transistor for the second pixel row.

9. The computer of claim 8, wherein a gate of the switch transistor for the first pixel is coupled to the first gate line at a bottom of the first pixel and a gate for the switch transistor for the second pixel is coupled to the first gate line at a top of the second pixel.

10. The computer of claim 7, wherein the display further comprises a conductive layer in communication with the pixel controller, wherein the conductive layer activates the common electrode for the first pixel and the second pixel.

11. The computer of claim 10, wherein the transistor layer further includes one or more conductive apertures that communicatively connect the common electrode to the conductive layer.

12. The computer of claim 10, wherein the conductive layer is formed of a metallic element.

13. The computer of claim 7, wherein each pixel in the first pixel row and each pixel in the second pixel row further comprises a liquid crystal layer in communication with the transistor layer, wherein the switch transistor selectively aligns crystals in the liquid crystal layer.

14. The computer of claim 7, wherein the first gate line provides the charge to the first pixel and the second pixel substantially simultaneously.

15. The computer of claim 7, wherein the each pixel of the display further comprises a color filter.

16. An electronic display comprising:
a first pixel row having a first pixel and a first pixel electrode;
a second pixel row having a second pixel and a second pixel electrode;
a switching layer in communication with the first pixel and the second pixel, wherein the switching layer selectively activates the first pixel and the second pixel, the switching layer including
a first switch transistor in communication with the first pixel electrode; and
a second switch transistor in communication with the second pixel electrode;
a pixel controller in communication with the first pixel and the second pixel, wherein the pixel controller selectively activates the switching layer, the pixel controller comprises
a first gate line;
a first drive line; and
a second drive line; wherein
the first gate line provide a charge to the first pixel electrode and the charge to the second pixel electrode; and
the first drive line activates the first switch transistor and the second drive line activates the second switch transistor.

17. The electronic display of claim 16, wherein the first gate line provides the charge to the first pixel electrode and the charge to the second pixel electrode substantially simultaneously.

18. The electronic display of claim 16, wherein the first switch transistor is inverted relative to the second switch transistor.

19. The electronic display of claim 18, wherein
the first switch transistor has a first gate; and
the second transistor has a second gate; wherein
the first gate is coupled to the first gate line at a bottom of the first pixel; and
the second gate is coupled to the second gate line at a top of the second pixel.

20. The electronic display of claim 16, further comprising
a conductive layer in communication with the pixel controller;
the switching layer further includes
a first common electrode for the first pixel; and
a second common electrode for the second pixel; wherein the conductive layer activates the first common electrode for the first pixel and the second common electrode for the second pixel.
